(19) United States
(12) Patent Application Publication
(10) Pub. No.: US 2024/0353676 A1
(43) Pub. Date: Oct. 24, 2024

(54) HEAD-UP DISPLAY

(71) Applicant: Nippon Seiki Co., Ltd., Niigata (JP)

(72) Inventors: Hiroyuki Furusawa, Nagaoka (JP); Masao Satoh, Nagaoka (JP)

(21) Appl. No.: 18/639,654

(22) Filed: Apr. 18, 2024

(30) Foreign Application Priority Data
Apr. 24, 2023 (JP) 2023-070917

(51) Int. Cl. G02B 27/00; G02B 27/01; G02B 27/02

(52) U.S. Cl. CPC G02B 27/0006; G02B 27/0149; G02B 27/024

(57) ABSTRACT

[Problem] To provide a head-up display excellent in visibility. A light transmitting sheet 60 has an emission window portion 63 that has a pair of left and right sides 63_{L} and 63_{R} and a pair of front and rear sides 63_{Fr} and 63_{Re}, and is a region from which the display light is emitted, a light shielding frame portion 64 that is at least partially fixed to a case 52 and is an opaque region, and a check window portion 65 formed along the pair of left and right sides 63_{L} and 63_{R} and the pair of front and rear sides 63_{Fr} and 63_{Re} within the light shielding frame portion 64 and allowing visual recognition of presence or absence of the adhesive disposed between the case 52 and the light transmitting sheet 60. A check window 65_{L} and 65_{R} along the pair of left and right sides 63_{L} and 63_{R} or a check window 65_{Fr} and 65_{Re} along the pair of front and rear sides 63_{Fr} and 63_{Re} is such that the check window along one side has a smaller area than the check window along the other side of the pair.

### CROSS-REFERENCE TO RELATED APPLICATIONS

The present application claims priority from Japanese Patent Application No. 2023-070917 filed on Apr. 24, 2023, the entire contents of which are hereby incorporated by reference.

### TECHNICAL FIELD

The present disclosure relates to a head-up display in which an opening for emitting display light is covered with a light transmitting sheet.

### BACKGROUND ART

A head-up display emits display light from the opening portion of a case to the outside of an apparatus. The display light emitted to the outside of the apparatus is irradiated on a windshield of a vehicle, and a virtual image of the display light is displayed in front of the windshield when viewed from a viewer such as a driver in the vehicle.

The opening portion from which the display light is emitted is covered with a light transmitting sheet for dust prevention. For example, in Patent Document 1, the light transmitting sheet is fixed to the peripheral edge of the opening portion by an adhesive applied to the peripheral edge portion.

The light transmitting sheet has a light shielding frame portion for shielding the adhesive from a viewer and a check window portion which is formed in the light shielding frame portion and enables the application state of the adhesive to be visually checked.

### PRIOR ART DOCUMENT

### Patent Document

Patent Document 1: Japanese Unexamined Patent Application Publication No. 2021-014153

### SUMMARY OF INVENTION

### Technical Problem

The head-up display of Patent Document 1 has an advantage that the adhesion state can be suitably grasped due to the presence of the check window portion. However, when the external light is reflected by the check window portion, the reflected light of the external light other than the display light is visually recognized by the viewer, and there is a concern that the visibility of the virtual image may be reduced.

In view of the above-described problem, it is an object of the present disclosure to provide a head-up display having excellent visibility.

### Solution to Problem

In order to solve the abovementioned problem, a head-up display according to the present disclosure is a head-up display that projects display light onto a projection member curved to be convex forward in such a manner that an inclination of left and right ends in a left-right direction is large with respect to a center in the left-right direction and that an upper end in an up-down direction has a larger inclination than a lower end with respect to the up-down direction, from behind and allows a viewer to visually recognize a virtual image based on the display light reflected by the projection member in front of the projection member. The head-up display includes a case having an opening portion, a displayer housed in the case and outputting display light emitted from the opening portion, and a light transmitting sheet that covers the opening portion and is fixed to the case with an adhesive. The light transmitting sheet has an emission window portion that has a pair of left and right sides located on left and right ends of the light transmitting sheet and a pair of front and rear sides located on front and rear ends of the light transmitting sheet, and is a region from which the display light is emitted, a light shielding frame portion that is arranged outside the pair of left and right sides and the pair of front and rear sides, is at least partially fixed to the case, and is an opaque region, and a check window portion formed along the pair of left and right sides and the pair of front and rear sides within the light shielding frame portion and allowing visual recognition of presence or absence of the adhesive disposed between the case and the light transmitting sheet. A check window along the pair of left and right sides or a check window along the pair of front and rear sides is such that the check window along one side has a smaller area than the check window along the other side of the pair.

### Advantageous Effects of Invention

According to the present disclosure, it is possible to provide a head-up display having excellent visibility.

### BRIEF DESCRIPTION OF DRAWINGS

FIG. 1 is a schematic configuration diagram of a head-up display in the present embodiment and a vehicle as a mounting destination.

FIG. 2 is an exploded perspective view of an upper case.

FIG. 3 is a partial cross-sectional view of an upper sheet for explaining adhesion between the upper case and a light transmitting sheet.

FIG. 4 is a conceptual diagram illustrating the emission direction of display light from the head-up display when the vehicle is a right-hand drive vehicle.

FIG. 5 is variation 1 of a check window.

FIG. 6 is variation 2 of the check window.

### DESCRIPTION OF EMBODIMENTS

Embodiments of a head-up display (hereinafter referred to as “HUD”) of the present disclosure will be described below on the basis of the accompanying drawings.

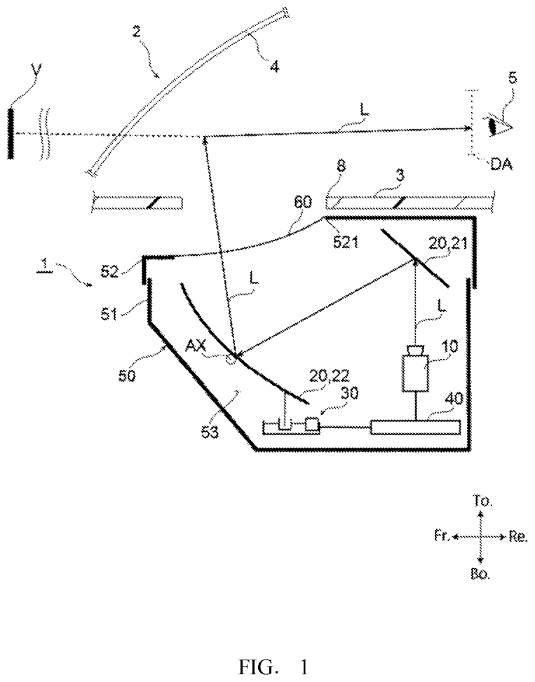

FIG. 1 is a schematic configuration diagram of a HUD1 and a vehicle 2 as a mounting destination in the present embodiment.

In the following description, “front”, “rear”, “right”, “left”, “upper” and “lower” are in accordance with the definitions “Fr.”, “Re.”, “R”, “L”, “To.” and “Bo.” in FIGS. 1 to 4.

The HUD1 is mounted on an instrument panel 3 in the vehicle 2 and emits display light L from an opening portion 8 of the instrument panel 3. The HUD1 projects and reflects the display light L onto a windshield 4 of the vehicle 2 from behind. When a viewer 5 (for example, a driver) who is an occupant of the vehicle 2 views the windshield 4 from a visible region DA, the viewer 5 can visually recognize a virtual image V based on the display light L in front of the windshield 4. The display light L represents, for example, vehicle information such as a traveling speed of the vehicle 2, warning information of the vehicle 2, and route guidance information.

The windshield 4 is located in front of the HUD1 and functions as a projection member of the HUD1. The windshield 4 is curved to be convex forward in such a manner that an inclination of left and right ends in a left-right direction is large with respect to a center in the left-right direction and that an upper end in an up-down direction has a larger inclination than a lower end with respect to the up-down direction.

The HUD1 mainly includes a displayer 10, a reflector 20, a driver 30, a controller 40, and a case 50 that houses these components.

The displayer 10 is a display device that displays an image, such as a liquid crystal display, an organic EL display, or a rear projection type projector. The displayer 10 displays an image representing vehicle information and outputs display light L representing this image.

The reflector 20 is a reflecting mirror that reflects the display light L. The reflector 20 includes a plane mirror 21 and a concave mirror 22. The plane mirror 21 reflects the display light L output from the displayer 10 toward the concave mirror 22. The concave mirror 22 reflects the light reflected by the plane mirror 21 toward the windshield 4.

The driver 30 is a drive mechanism that rotates the concave mirror 22 about a rotary shaft AX. For example, the driver 30 rotates the concave mirror 22 by the rotation of a motor.

The controller 40 is a control circuit board that controls the displayer 10 and the driver 30. The controller 40 causes the displayer 10 to display an image representing the vehicle information. In addition, the controller 40 can adjust the position of the visible region DA in accordance with the height of the eyes of the viewer 5 by controlling the driver 30.

Specifically, the controller 40 can change the position of the display light L projected on the windshield 4 and move the visible region DA up and down by controlling the driver 30 to rotate the concave mirror 22.

The case 50 is a black resin case made of polycarbonate or the like. The case 50 includes a lower case 51 and an upper case 52. The case 50 includes a housing section 53 which is a space covered by the lower case 51 and the upper case 52. The housing section 53 houses the displayer 10, the reflector 20, the driver 30, and the controller 40.

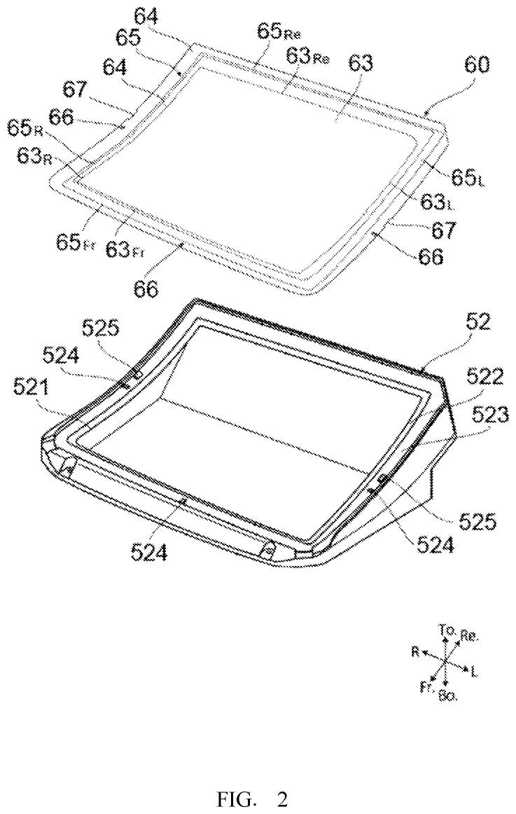

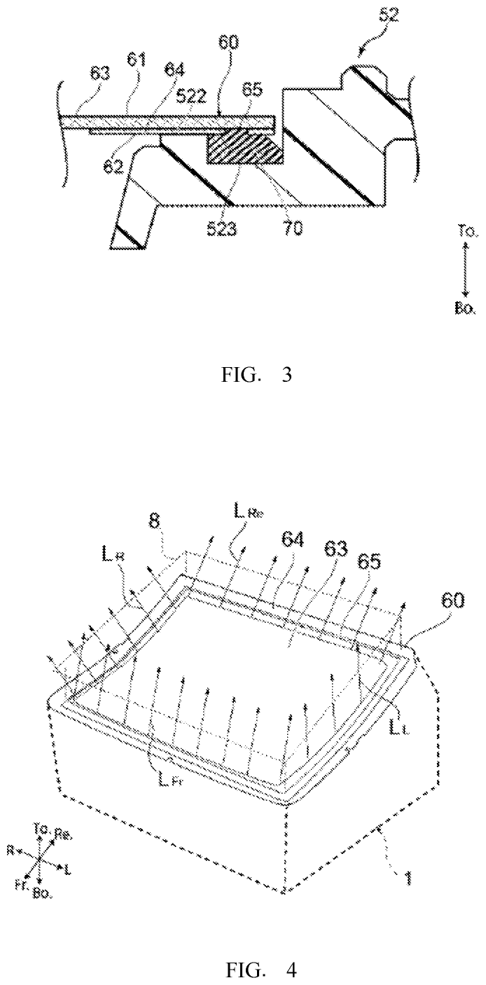

FIG. 2 is an exploded perspective view of the upper case 52. FIG. 3 is a partial cross-sectional view of the upper case 52 for explaining adhesion between the upper case 52 and a light transmitting sheet 60.

The upper case 52 has an opening portion 521 for emitting the display light L to the outside of the case 50. The upper case 52 includes the light transmitting sheet 60 that covers the opening portion 521.

On the outer edge of the opening portion 521 of the upper case 52, a frame-shaped placement portion 522 surrounding the opening portion 521 is formed. The placement portion 522 supports the light transmitting sheet 60. The placement portion 522 has a curved surface inclined with respect to the front-rear direction of the vehicle 2. Due to this curved surface, external light such as sunlight does not travel toward the visible region DA via the windshield 4 after being reflected by the light transmitting sheet 60.

On the outer edge of the placement portion 522 of the upper case 52, a frame-shaped adhesion portion 523 surrounding the placement portion 522 is formed. An adhesive 70 is applied to the adhesion portion 523, and the adhesive 70 fixes the light transmitting sheet 60 supported by the placement portion 522 to the upper case 52. The adhesion portion 523 is a recessed groove recessed by one step from the placement surface of the placement portion 522. The outer edge of the light transmitting sheet 60 is bonded in a state of being in contact with the frame-shaped placement portion 522 by the adhesive 70, and thus the dustproof property is high.

The upper case 52 includes a positioning portion 524 and a stopper portion 525. The positioning portion 524 positions the light transmitting sheet 60 on the placement portion 522 at three positions in the surface direction of the light transmitting sheet 60.

The stopper portion 525 prevents the light transmitting sheet 60 from peeling off and falling off from the upper case 52 at two positions. The stopper portion 525 is formed at a position separated from the placement surface of the placement portion 522 by a predetermined distance in a direction orthogonal to the surface direction of the light transmitting sheet 60. When the light transmitting sheet 60 is elastically deformed along the curved surface of the placement portion 522 and is in contact therewith, the light transmitting sheet 60 and the stopper portion 525 are not in contact with each other. When the light transmitting sheet 60 is separated from the curved surface and the elastic deformation amount returns to a predetermined deformation amount, the light transmitting sheet 60 abuts on the stopper portion 525. That is, the stopper portion 525 is provided at a location where the curvature of the curved surface of the placement portion 522 is the highest. Therefore, when the light transmitting sheet 60 placed in a state of being elastically deformed along the curved surface is restored, it is possible to prevent the light transmitting sheet 60 from falling off from the upper case 52 by having the stopper portion 525.

The light transmitting sheet 60 functions as a dustproof cover that covers the opening portion 521. The light transmitting sheet 60 mainly includes a base material 61 and a print layer 62. The base material 61 is a thin plate-like member made of a translucent resin such as an acrylic resin or a polycarbonate resin. The print layer 62 is a black print layer formed in a predetermined region of the periphery of the base material 61. The print layer 62 is formed on the surface of the base material 61 facing the placement portion 522 and the adhesion portion 523, and thus it is possible to prevent deterioration or the like of the print layer 62 due to chemicals or physical load from the outside.

The print layer 62 forms an emission window portion 63, a light shielding frame portion 64, and a check window portion 65 on the light transmitting sheet 60.

The emission window portion 63 is a region defined by the inner peripheral edge of the print layer 62, and is a region that transmits the display light L emitted toward the opening portion 521 and emits the display light L toward the windshield 4. The emission window portion 63 has a pair of left and right sides 63_{L} and 63_{R} located on the left and right end sides of the light transmitting sheet 60 and a pair of front and rear sides 63_{Fr} and 63_{Re} located on the front and rear end sides.

The light shielding frame portion 64 is a frame-shaped region formed outside the emission window portion 63 so as to surround the emission window portion 63. The light shielding frame portion 64 is an opaque region which covers the edge of the opening portion 521 and the placement portion 522, shields the placement portion 522 and the adhesive 70, and suppresses the reflection of external light such as sunlight.

The light shielding frame portion 64 is arranged outside the pair of left and right sides 63_{L} and 63_{R} and the pair of front and rear sides 63_{Fr} and 63_{Re} of the emission window portion 63, and at least a part of the light shielding frame portion 64 is fixed to the upper case 52 by the adhesive 70.

The check window portion 65 is formed by cutting a part of the print layer 62 forming the light shielding frame portion 64, that is, by not forming a part of the print layer 62. The check window portion 65 is formed along the pair of left and right sides 63_{L} and 63_{R} and the pair of front and rear sides 63_{Fr} and 63_{Re} in the light shielding frame portion 64. The check window portion 65 enables the presence or absence of the adhesive 70 applied to the adhesion portion 523 and the state of adhesion to be visually recognized through the light transmitting sheet 60. The size of the check window portion 65 is determined in accordance with the lower limit amount of the application amount of the adhesive 70 applied to the adhesion portion 523 in such a manner that the adhesion failure can be checked by visually or mechanically image-inspecting the check window portion 65.

The light transmitting sheet 60 has a positioning slit 66 and an assembling slit 67. The positioning slit 66 is formed at a position corresponding to the positioning portion 524 of the upper case 52, and is engaged with the stopper portion 525 to position the light transmitting sheet 60 with respect to the surface direction. The assembling slit 67 is formed at a position corresponding to the stopper portion 525 of the lower case 51, and is engaged with the stopper portion 525 to improve the assemblability of the light transmitting sheet 60.

The adhesive 70 is a liquid adhesive 70. The adhesive 70 is cured after being applied to the adhesion portion 523, and the upper case 52 and the light transmitting sheet 60 are bonded and fixed to each other at the adhesion portion 523. The adhesive 70 is a hot-melt adhesive, a photo-curing adhesive or various synthetic resin adhesives. The adhesive 70 is preferably colored in a color (for example, blue or purple) different from the color of the upper case 52. The adhesive 70 is preferably a hot-melt adhesive or a photo-curing adhesive having a short curing time in consideration of manufacturability. In particular, in the case of a photo-curing adhesive, the check window portion 65 can be used for both check of the applied adhesive 70 and check of irradiation of light for curing (ultraviolet rays or infrared rays).

Here, since the HUD1 has the check window portion 65, it is possible to easily check the adhesion failure by performing inspection visually or using a photographed image through the check window portion 65. However, when the check window portion 65 is formed, a translucent region is formed in a region where the light shielding frame portion 64 should suppress reflection of external light, and thus there is a concern that reflection of external light may occur. When the external light is reflected by the check window portion 65, the reflected light which should not reach the viewer is reflected on the windshield 4, and there is a concern that the visibility of the display of the display light L is reduced.

On the other hand, from the viewpoint of the adhesiveness of the light transmitting sheet 60 at the time of use in the HUD1, it is also necessary to check whether the adhesive 70 reliably adheres the adhesion portion 523 and the light shielding frame portion 64. Therefore, in view of the adhesiveness of the adhesive 70 at the time of assembly, it is also necessary to form the check window portion 65 having a required area.

Accordingly, in the HUD1 of the present embodiment, the check window portion 65 is formed in consideration of the emission direction of the display light L when the HUD1 is mounted in the vehicle 2 and the arrangement of the HUD1 with respect to the opening portion 8 of the instrument panel 3. That is, as descrived above, the windshield 4 of the vehicle 2 is curved to be convex forward in such a manner that an inclination of left and right ends in a left-right direction is large with respect to a center in the left-right direction and that an upper end in an up-down direction has a larger inclination than a lower end with respect to the up-down direction. The HUD1 controls the emission direction of the display light L in the left-right direction and the front-rear direction in consideration of such a shape of the windshield 4.

Here, FIG. 4 is a conceptual diagram illustrating the emitting direction of the display light L of the HUD1 in a case where the vehicle 2 is a right-hand drive vehicle.

In the HUD1, in a case where the vehicle 2 is a right-hand drive vehicle, in order to allow the display light L to reach the visible region DA, in consideration of the difference in inclination of the windshield 4 in the left-right direction, of the display light, the display light LR emitted from the emission window portion 63 on the right end side with respect to the center in the left-right direction is emitted so as to be refracted toward the right end side more than the display light LL emitted from the emission window portion 63 toward the center in the left-right direction. In addition, in consideration of the difference in inclination of the windshield 4 in the up-down direction, of the display light, the display light L_{Re} emitted from the emission window portion 63 on the rear end side toward the upper end side is emitted so as to be refracted toward the rear end side more than the display light L_{Fr} emitted from the emission window portion 63 on the front end side toward the lower end side.

Further, the instrument panel 3 is required to shield the inside thereof within a range in which the optical path of the display light L is not blocked in such a manner that the HUD1 is not visually recognized by the viewer 5 or unnecessary external light does not enter the HUD1. As described above, since the inclination of the display light L with respect to each direction is different in the left-right direction and the front-rear direction, the opening portion 8 of the instrument panel 3 is also formed in accordance with this. That is, as illustrated in FIG. 4, it is necessary for the opening portion 8 to expose the light transmitting sheet 60 (upper case 52) more greatly on the right end side of the HUD1 than on the left end side, and to expose the light transmitting sheet 60 more greatly on the rear end side than on the front end side.

However, if the light transmitting sheet 60 is exposed to a large extent, the check window portion 65, which should be a shielded region, is exposed. As a result, the external light is reflected by the check window portion 65 formed along the right side 63_{R} and the rear side 63_{Re} of the emission window portion 63 and is reflected on the windshield 4, and thus there is a concern that the visibility of the virtual image V according to the display light L may be reduced.

Accordingly, in the HUD1 of the present embodiment, as illustrated in FIGS. 2 and 4, the areas of the check window portions 65 are made different in accordance with the exposed ranges from the opening portion 8 of the instrument panel 3. That is, when the vehicle 2 is a right-hand drive vehicle, the check window portion 65_{R} arranged along the right side 63_{R} of the emission window portion 63 located on the right end side with respect to the center in the left-right direction of the windshield 4 is narrower than the check window portion 65_{L} arranged along the left side 63_{L} so as to have a smaller area.

In addition, the check window portion 65_{Re} arranged along the rear side 63_{Re} located on the rear side is narrower than the check window portion 65_{Fr} arranged along the front side 63_{Fr} so as to have a smaller area.

When the vehicle 2 is a left-hand drive car, the emission direction of the display light L and the exposure range from the opening portion 8 are also bilaterally symmetrical as the shape of the windshield 4 is bilaterally symmetrical. For this reason, the check window portion 65 is formed bilaterally symmetrically in FIGS. 2 and 4. That is, when the vehicle 2 is a left-hand drive car, the check window portion 65_{L} arranged along the left side 63_{L} of the emission window portion 63 located on the left end side with respect to the center in the left-right direction of the windshield 4 is narrower than the check window portion 65_{R} arranged along the right side 63_{R} so as to have a smaller area.

In such a HUD1 in the present embodiment, the area of the check window portion 65 is set in accordance with the amount of exposure from the opening portion 8 of the instrument panel 3, and thus the possibility of reflection of external light in the check window portion 65 can be reduced. Therefore, a HUD 1 with excellent visibility can be provided.

Although some embodiments of the head-up display of the present disclosure have been described, these embodiments are presented by way of example and are not intended to limit the scope of the claims. These novel embodiments can be implemented in various other forms, and various omissions, replacements, and changes can be made without departing from the gist of the invention. These embodiments and modifications thereof are included in the scope and gist of the invention, and are included in the invention described in the claims and the equivalents thereof.

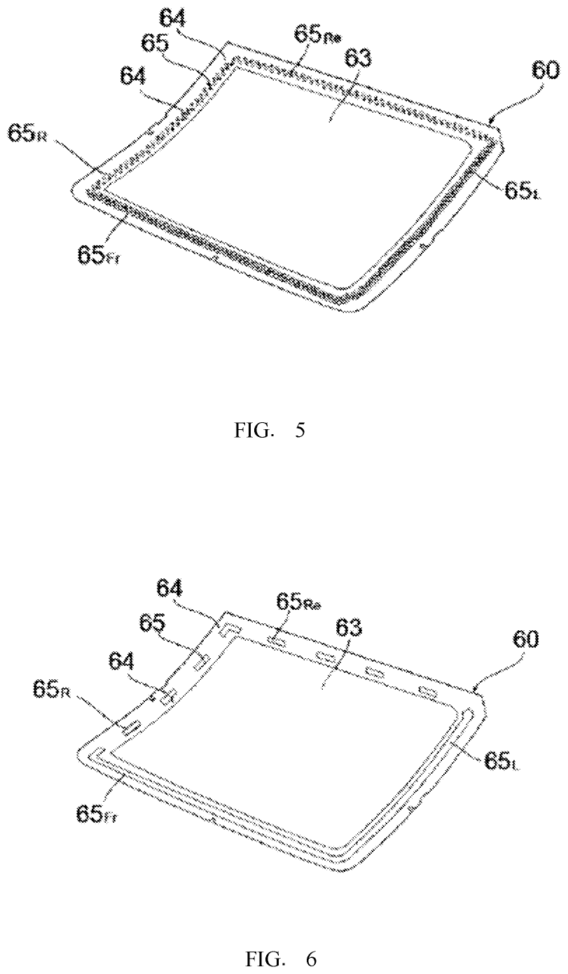

For example, it is preferable that the check window portion 65 is a region continuously formed in a frame shape along the circumferential direction from the viewpoint of checking adhesion. However, as a method of relatively reducing the area of the check window portion 65, an example of reducing the width has been described, but the present invention is not limited thereto. For example, as illustrated in FIG. 5, the check window portion 65 may be formed in a dot shape instead of being formed in a linear frame shape. In this case, when the vehicle 2 is a right-hand drive vehicle, the formation densities of the dots forming the check window portion 65_{R} and the check window portion 65_{Re} may be smaller than those of the check window portions 65_{L} and 65_{Fr}, or the diameters of the dots may be smaller.

Further, as illustrated in FIG. 6, the check window portions 65_{R} and 65_{Re} may be intermittently formed and the check window portions 65_{L} and 65_{Fr} may be continuously formed to have different lengths in such a manner that the check window portions 65_{R} and 65_{Re} have smaller areas than the check window portions 65_{L} and 65_{Fr}.

### REFERENCE SIGNS LIST

1 Head-up display (HUD)
2 Vehicle
3 Instrument panel
4 Windshield
5 Viewer
7 Adhesive
8 Opening portion
10 Displayer
20 Reflector
21 Plane mirror
22 Concave mirror
30 Driver
40 Controller
50 Case
51 Lower case
52 Upper case
53 Housing section
60 Light transmitting sheet
61 Base material
62 Print layer
63 Emission window portion
64 Light shielding frame portion
65 Check window portion
66 Positioning slit
67 Assembling slit
70 Adhesive
521 Opening portion
522 Placement portion
523 Adhesion portion
524 Positioning portion
525 Stopper portion
Ax Rotary shaft
DA Visible region
L Display light
V Virtual image

1. A head-up display that projects display light onto a projection member curved to be convex forward in such a manner that an inclination of left and right ends in a left-right direction is large with respect to a center in the left-right direction and that an upper end in an up-down direction has a larger inclination than a lower end with respect to the up-down direction, from behind and allows a viewer to visually recognize a virtual image based on the display light reflected by the projection member in front of the projection member, the head-up display comprising:
a case having an opening portion;
a displayer housed in the case and outputting the display light emitted from the opening portion; and
a light transmitting sheet that covers the opening portion and is fixed to the case with an adhesive,
the light transmitting sheet having:
an emission window portion that has a pair of left and right sides located on left and right ends of the light transmitting sheet and a pair of front and rear sides located on front and rear ends of the light transmitting sheet, and is a region from which the display light is emitted;
a light shielding frame portion that is arranged outside the pair of left and right sides and the pair of front and rear sides, is at least partially fixed to the case, and is an opaque region; and
a check window portion formed along the pair of left and right sides and the pair of front and rear sides within the light shielding frame portion and allowing visual recognition of presence or absence of the adhesive disposed between the case and the light transmitting sheet,
wherein a check window along the pair of left and right sides or a check window along the pair of front and rear sides is such that the check window along one side has a smaller area than the check window along the other side of the pair.

2. The head-up display according to claim 1,
wherein the light shielding frame portion is a print layer formed on a surface of the light transmitting sheet facing the case, and
wherein the check window portion is a region where the print layer is cut.

3. The head-up display according to claim 1, wherein the check window portion is a frame-shaped region that is continuously formed along the pair of left and right sides and the pair of front and rear sides.
